(19) United States
(12) Patent Application Publication
(10) Pub. No.: US 2010/0089020 A1
(43) Pub. Date: Apr. 15, 2010

(54) METERING OF DILUENT FLOW IN COMBUSTOR

(75) Inventors: Jesse Ellis Barton, Simpsonville, SC (US); Jonathan Dwight Berry, Simpsonville, SC (US); Mark Allan Hadley, Greer, SC (US); John Drake Vanselow, Taylors, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/250,933

(22) Filed: Oct. 14, 2008

(51) Int. Cl. F02C 3/20; F02C 3/30

(52) U.S. Cl. 60/39.53; 60/734; 60/775

(57) ABSTRACT

Disclosed is a combustor including a baffle plate having at least one through baffle hole and at least one fuel nozzle extending through the at least one baffle hole. A circumferentially adjustable collar is located at the at least one baffle hole between the baffle plate and the at least one fuel nozzle. A plurality of openings at the collar are configured to meter a flow of diluent between the baffle hole and the at least one fuel nozzle. Further disclosed is a method for providing diluent to a combustor including providing a plurality of openings disposed at a circumferentially adjustable collar between a baffle plate and at least one fuel nozzle extending through a through hole in the baffle plate. The diluent is flowed through the plurality of openings toward at least one airflow hole in the at least one fuel nozzle.

### BACKGROUND OF THE INVENTION

The subject invention relates generally to combustors. More particularly, the subject invention relates to metering of diluent flow into a combustor via a fuel nozzle.

Combustors typically include one or more fuel nozzles that introduce a fuel or a mixture of fuel and air to a combustion chamber where it is ignited. In some combustors, the fuel nozzles extend through holes disposed in a baffle plate of the combustor. In these combustors, it is often advantageous to introduce a volume of diluent, often nitrogen or steam, to the combustor to reduce NOₓ emissions and/or augment output of the combustor. The diluent is urged from a chamber through a gap between the baffle plate and each fuel nozzle, and then flows along a periphery of the fuel nozzle where a portion of the diluent enters the fuel nozzle via holes in the air collar of the fuel nozzle. The gaps between the baffle plate and the fuel nozzles, however, vary due to assembly tolerance stack-ups between the baffle plate and the fuel nozzles. The gap variation results in variation in diluent flow around each nozzle and throughout the combustor assembly. Further, an axial distance between the gap and the air collar holes in the fuel nozzle allow diluent to reach the combustion reaction zone without passing through the fuel nozzle and mixing directly with the fuel and air. Both of these effects reduce diluent efficiency and therefore a greater volume of diluent is required to achieve an equivalent amount of diluent flow into the fuel nozzle. The excess diluent that flows toward the combustion reaction zone without passing through the fuel nozzle leads to operability problems in the combustor such as dynamics and lean blow out.

### BRIEF DESCRIPTION OF THE INVENTION

According to one aspect of the invention, a combustor includes a baffle plate including at least one through baffle hole and at least one fuel nozzle extending through the at least one baffle hole. A circumferentially adjustable collar is located at the at least one baffle hole between the baffle plate and the at least one fuel nozzle. A plurality of openings at the collar are configured to meter a flow of diluent between the baffle hole and the at least one fuel nozzle.

According to another aspect of the invention, a method for providing diluent to a combustor includes providing a plurality of openings disposed at a circumferentially adjustable collar between a baffle plate and at least one fuel nozzle extending through a through hole in the baffle plate. The diluent is flowed through the plurality of openings toward at least one airflow hole in the at least one fuel nozzle.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a cross-sectional view of an embodiment of a combustor;

FIG. 2 is an end view of an embodiment of a baffle plate assembly of a combustor;

FIG. 3 is a cross-sectional view of floating collar of the baffle plate assembly of FIG. 2;

FIG. 4 is a cross-sectional view of another embodiment of a floating collar of the baffle plate assembly of FIG. 2;

FIG. 5 is a partial perspective view of an embodiment of a cover ring that supplies diluent to a plenum defined by the baffle plate assembly of FIG. 2;

FIG. 6 is a cross-sectional view of an embodiment of a floating collar with a separate shroud;

FIG. 7 is a cross-sectional view of an embodiment of a floating collar having slotted openings; and

FIG. 8 is a cross-sectional view of an embodiment of a baffle plate assembly utilizing slotted openings in the fuel nozzle for diluent metering and delivery.

The detailed description explains embodiments of the invention, together with advantages and features, by way of example with reference to the drawings.

### DETAILED DESCRIPTION OF THE INVENTION

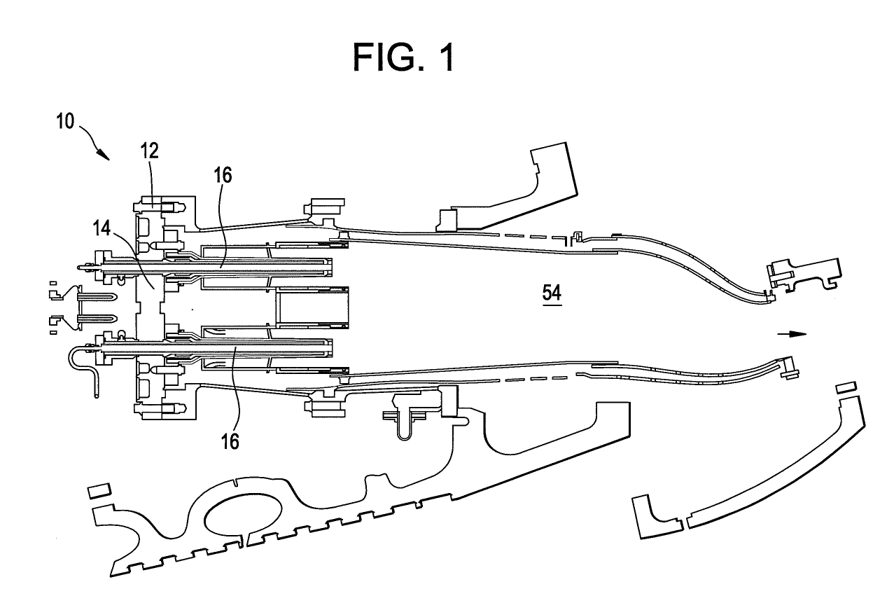

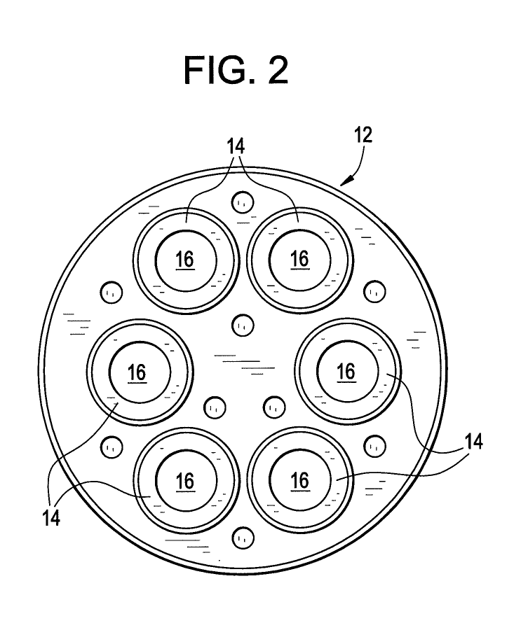

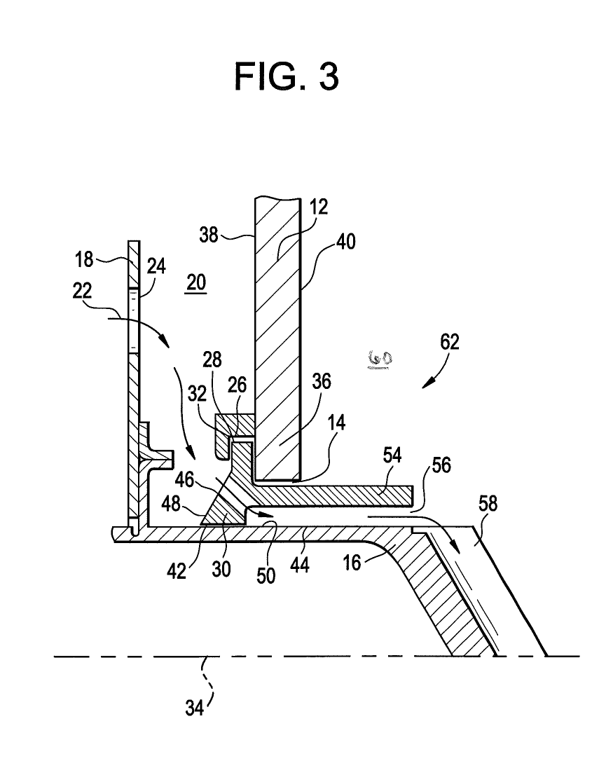

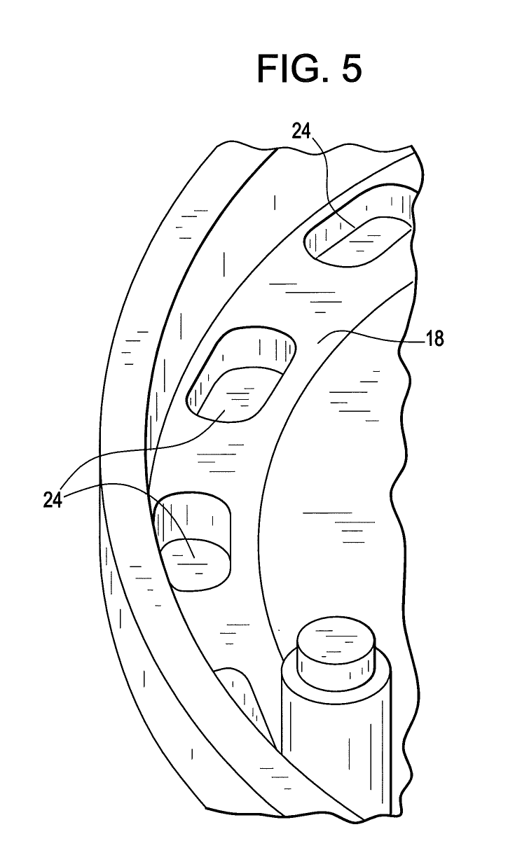

Shown in FIG. 1 is a combustor 10. The combustor 10 includes a baffle plate 12 having six baffle holes 14, through which six fuel nozzles 16 extend, for example, one fuel nozzle 16 extending through each baffle hole 14, as best shown in FIG. 2. While six fuel nozzles 16 are shown in FIG. 2, it is to be appreciated that other quantities of fuel nozzles 16, for example, one or four fuel nozzle 16, may be utilized. As shown in FIG.3, the baffle plate 12 and a cover ring 18 define a plenum 20 into which a diluent flow 22 is guided via an array of orifices 24 (best shown in FIG. 5) in the cover ring 18. In some embodiments, the diluent flow 22 may comprise steam, or other diluents such as nitrogen.

At each fuel nozzle 16, as shown in FIG. 3, a collar 26 is disposed at the baffle hole 14 between the baffle plate 12 and the fuel nozzle 16. In the embodiment of FIG. 3, the collar 26 includes a locating flange 28 extending from a collar body 30. The locating flange 28 is disposed in a locating pocket 32 of the baffle plate 12, to locate the collar 26 in an axial direction, substantially parallel to a central axis 34 of the fuel nozzle 16, but allows the collar 26 to float or move in a radial direction an amount substantially equal to a depth 36 of the locating pocket 32. This allows for positioning of the collar 26 to compensate for assembly situations where the fuel nozzle 16 is misaligned in the baffle hole 14 due to, for example, component manufacturing tolerances. The locating pocket 32 of FIG. 3 is secured to a rear face 38 the baffle plate 12 by welding, but it is to be appreciated that the locating pocket 32 may be secured to the baffle plate 12 by other means such as, for example, one or more mechanical fasteners, by brazing, or by the use of adhesives. Further, in some embodiments, the locating pocket 32 may be secured to other portions of the baffle plate 12, for example a forward face 40 of the baffle plate 12.

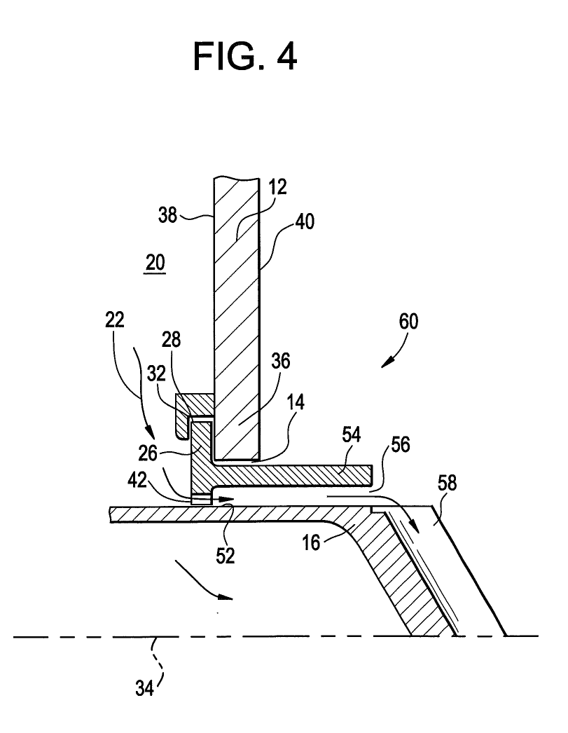

The collar body 30 of FIG. 3 includes a base 42 which substantially abuts an outer surface 44 of the fuel nozzle 16, and prevents leakage between the base 42 and the outer surface 44. The collar body 30 further includes a plurality of metering openings 46 extending through the collar body 30 from an upstream side 48 to a downstream side 50 and which are configured to allow diluent flow 22 to be flowed therethrough. The plurality of metering openings 46 may extend substantially parallel to the central axis 34 or, as shown in FIG. 3, may be disposed at an angle relative to the central axis 34. Further, as shown in FIG. 4, in some embodiments the plurality of metering openings 46 may comprise a plurality of slots 52 in the base 42.

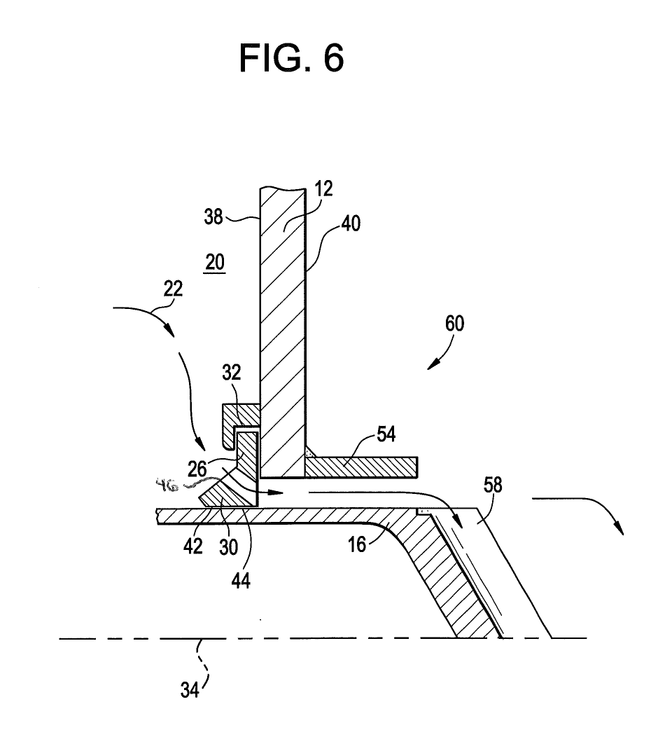

The collar 26 of FIG. 3 includes a shroud 54 extending from the collar body 30 along the fuel nozzle 16 outer surface 44 downstream of the collar body 30. The shroud 54 and the outer surface 44 define a flow channel 56 therebetween to direct the diluent flow 22 from the plurality of metering openings 46 toward a plurality of airflow holes 58 in the fuel nozzle 16. In another embodiment as shown in FIG. 6, the collar body 30 does not include the shroud 54, but the shroud extends from the baffle plate 12 from, for example, the forward face 40.

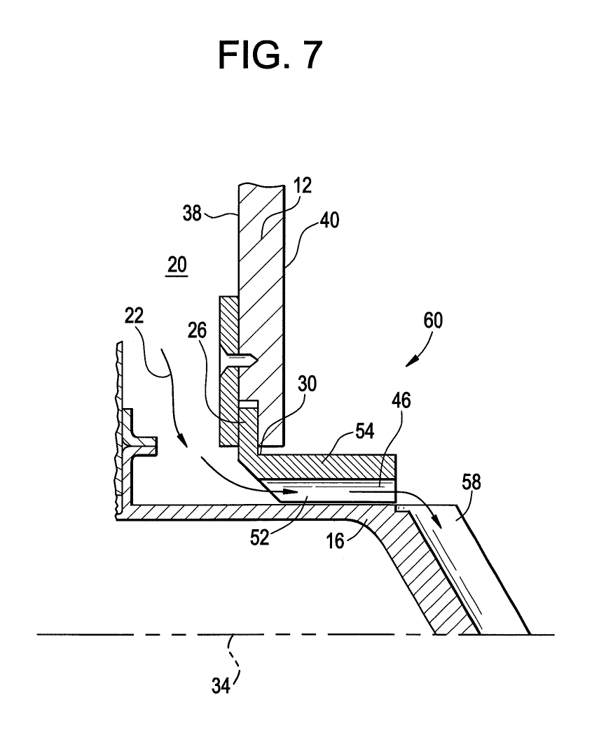

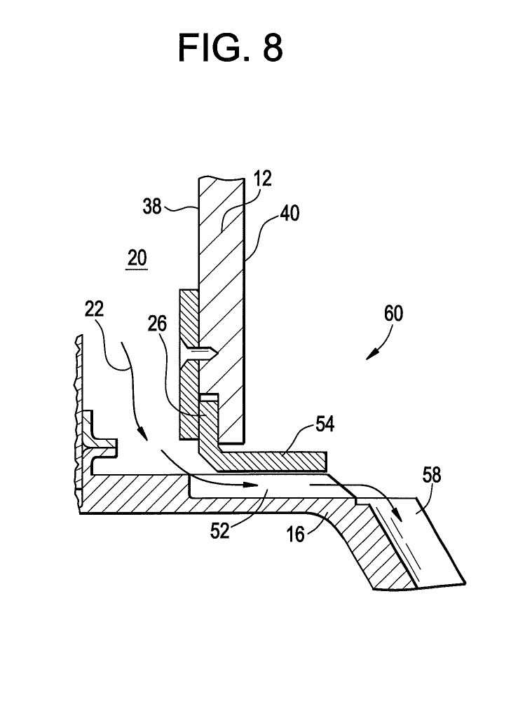

Referring now to FIG. 7, in one embodiment the shroud 54 is integral to the collar body 30 and the plurality of metering openings 46 extend through both the collar body 30 and the shroud 54 to guide diluent flow 22 toward the airflow holes 58. In some embodiments, and as shown in FIG. 7, the plurality of metering openings 46 comprise a plurality of slots 52. Alternatively, as shown in FIG. 8, to better ensure circumferential alignment between the plurality of slots 52 and the plurality of airflow holes 58, the plurality of slots 52 are included in the fuel nozzle 16. By including the plurality of slots 52 in the fuel nozzle 16 a desired alignment of the plurality of slots 52 to the plurality of airflow holes 58 can be determined during fabrication of the fuel nozzle 16 without needing to rely on the establishment of design features to guarantee alignment. In the embodiment of FIG. 8, the shroud 54 is substantially an annular shape which is located outboard of the plurality of slots 52 to, together with the slots 52, define the plurality of metering openings 46.

In operation, the diluent flow 22 is guided from the plenum 20 and through the plurality of metering openings 46. Once through the metering openings 46, the diluent flow 22 is introduced to an exterior 60 of the baffle plate 12 at a head end 62 of the combustor 10 in close proximity to the plurality of air flow holes 58 in the fuel nozzle 16. At least a portion of the diluent flow 22 enters the plurality of air flow holes 58 and is mixed with air and fuel in the nozzle 16. Guiding the diluent flow 22 through the plurality of metering openings 46 allows injection of the diluent flow 22 nearby the air flow holes 58 to increase efficiency of the diluent flow 22. Further, the diluent flow 22 is metered via the metering openings 46 and is consistent around the baffle plate 12 due to allowing the collar 26 to locate in a circumferential direction based on location of the fuel nozzle 16 relative to the baffle opening 14. Thus, a volume of diluent flow 22 required is reduced thereby reducing operability issues such has dynamics and lean blow out.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor comprising:
a baffle plate including at least one through baffle hole;
at least one fuel nozzle extending through the at least one through baffle hole;
a circumferentially adjustable collar disposed at the at least one through baffle hole between the baffle plate and the at least one fuel nozzle; and
a plurality of openings at the collar configured to flow a flow of diluent between the at least one through baffle hole and the at least one fuel nozzle.

2. The combustor of claim 1 wherein the collar is at least partially insertable into a pocket of the baffle plate.

3. The combustor of claim 1 wherein the plurality of openings comprise a plurality of holes through the collar.

4. The combustor of claim 1 wherein the plurality of openings comprise a plurality of slots in an inboard surface of the collar.

5. The combustor of claim 1 wherein the plurality of openings comprise a plurality of slots in an outer surface of the at least one fuel nozzle.

6. The combustor of claim 1 wherein each opening of the plurality of openings substantially aligns circumferentially with an airflow hole of a plurality of airflow holes in the at least one fuel nozzle.

7. The combustor of claim 1 wherein a shroud extends downstream from the collar to guide diluent flow toward a plurality of airflow holes in the at least one fuel nozzle.

8. The combustor of claim 7 wherein the shroud is integral to the collar.

9. The combustor of claim 8 wherein the plurality of openings extend through the shroud.

10. The combustor of claim 7 wherein the shroud is secured to the baffle plate.

11. The combustor of claim 1 wherein the plurality of openings extend substantially parallel to a central axis of the at least one fuel nozzle.

12. The combustor of claim 1 wherein the diluent is at least one of steam and/or nitrogen.

13. A method for providing diluent to a combustor comprising:
providing a plurality of openings disposed at a circumferentially adjustable collar between a baffle plate and at least one fuel nozzle extending through at least one through hole in the baffle plate; and
flowing the diluent through a plurality of openings toward at least one airflow hole in the at least one fuel nozzle.

14. The method of claim 13 comprising flowing the diluent along a flow channel defined by a shroud extending downstream of the baffle plate and an outer surface of the at least one fuel nozzle.

15. The method of claim 13 comprising flowing at least a portion of the diluent into the at least one airflow hole in the at least one fuel nozzle.

16. The method of claim 13 wherein flowing the diluent through a plurality of openings comprises flowing the diluent through a plurality of holes in the collar.

17. The method of claim 13 wherein flowing the diluent through a plurality of openings comprises flowing the diluent through a plurality of slots in an outer surface of the at least one fuel nozzle.

18. The method of claim 13 wherein the diluent is at least one of steam and/or nitrogen.
